(19) United States
(12) Patent Application Publication
(10) Pub. No.: US 2005/0134164 A1
(43) Pub. Date: Jun. 23, 2005

(54) Optical coupler for projection display

(75) Inventors: Roy A. Auerbach, Cincinnati, OH (US); Gunnar Hans Gunnarsson, Cincinnati, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/739,461

(22) Filed: Dec. 18, 2003

(51) Int. Cl. H01J 29/10

(52) U.S. Cl. 313/474; 313/110

(57) ABSTRACT

An optical element is disclosed that includes a face plate of a cathode ray tube and a lens element facing the face plate. The optical element further includes an optical coupling material disposed between the lens element and the face plate. The optical coupling material includes particles dispersed in a host material.

### FIELD OF THE INVENTION

This invention generally relates to cathode ray tube (CRT) projection displays. The invention is particularly applicable to CRT projection displays having low thermal drift.

### BACKGROUND

CRT projection displays are commonly used in consumer applications, such as home entertainment centers, and commercial applications, such as video conferencing, information presentation, and data displays.

A CRT projection display typically includes a CRT image forming source and a projection system. The CRT image forming source forms a small image, for example, 12 to 25 cm in diagonal, at the output of the source. The projection system includes one or more, typically at least three, projection lens elements, employed to magnify and project the source image onto a projection screen.

More commonly, a CRT projection display includes three CRT image sources, one CRT for each primary color (red, green and blue). Typically, each CRT image source has it own dedicated projection system and projection lens elements. The projection systems magnify, project and superimpose the three source images onto a projection screen resulting in a projected color display.

A CRT projection display may be a front or rear projection display. In a front projection display, the image source and viewer are located on opposite sides of the viewing image plane. In contrast, in a rear projection display, the viewer is located on one side of the viewing image plane whereas the projection system and the image created by the source are located on the other side of the image plane. The viewing image is typically displayed on a projection screen which is typically reflective in a front projection display and transmissive in a rear projection display.

Optical reflections at the CRT glass plate and the first surface of the projection lens element closest to the source can reduce image brightness, contrast and resolution. To reduce optical reflection, a fluid medium is typically used to fill the space between and optically couple the CRT glass plate and a first lens element. Known fluids include ethylene glycol, mixtures of ethylene glycol and glycerol, mixtures of ethylene glycol and water, alkyl diaryl alkanes, liquids including a siloxane polymer having methyl, phenyl, and hydrophilic side groups, and liquids including mixtures of a siloxane polymer having methyl and phenyl side groups and a siloxane polymer having methyl and hydrophilic side groups.

### SUMMARY OF THE INVENTION

Generally, the present invention relates to CRT projection displays.

In one embodiment of the invention, an optical element includes a face plate of a cathode ray tube, a lens element facing the face plate, and an optical coupling material disposed between the lens element and the face plate. The optical coupling material includes particles dispersed in a host material.

In another embodiment of the invention, a projection display system includes a CRT image source having a face plate, and a lens element facing the face plate. The projection display system further includes an optical coupling material disposed between the lens element and the face plate. The optical coupling material includes particles dispersed in a host material.

In another embodiment of the invention, a cathode ray tube projection system includes a face plate of a cathode ray tube and a lens element. The face plate and the lens element are arranged in spaced-apart opposing positions defining a coupler cavity. The cathode ray tube projection system further includes a coupling fluid dispersed within the coupler cavity. The coupling fluid includes nano-particles.

### BRIEF DESCRIPTION OF DRAWINGS

The invention may be more completely understood and appreciated in consideration of the following detailed description of various embodiments of the invention in connection with the accompanying drawings, in which:

FIG. 1 illustrates a schematic side view of an optical element in accordance with one embodiment of the invention;

FIG. 2 illustrates a schematic side view of a CRT projection display in accordance with another embodiment of the invention; and

FIG. 3 illustrates a schematic side view of an optical element in accordance with yet another embodiment of the invention.

### DETAILED DESCRIPTION

The present invention generally relates to projection displays. The invention is particularly applicable to CRT projection displays, and even more particularly to CRT projection displays that have an optical coupling material between a CRT image source and a projection lens element.

Examples of CRT projection systems can be found in U.S. Pat. Nos. 4,838,665; 5,157,554; 5,381,189; 5,625,496 and 5,440,429; and U.S. Patent Publication Nos. 2002/0196556 and 2003/0071929.

Known optical coupling materials include coupling fluids that have a low index of refraction and a high rate of change in refractive index with fluid temperature, dn/dT. Examples of such couplers may be found in U.S. Pat. Nos. 5,117,162; 5,115,163; 4,982,289; 4,904,899; 4,780,640; 4,734,613; 4,725,755; 4,665,336; 4,405,949 and 4,651,217; and U.S. Publication Nos. 2003/0034727 and 2003/0098944. The index of refraction of known optical couplers is generally lower than the optical elements positioned on either side of the optical coupler, and which the optical coupler is designed to optically couple. For example, the index of refraction of known coupling fluids is about 1.43. In contrast, index of refraction of a face plate is about 1.56, and index of refraction of lens elements is approximately in the range from 1.49 to 1.53. An index mismatch between an optical coupling material and the CRT glass plate and/or the first projection lens element, the two media the fluid coupler is designed to optically couple, can result in residual optical reflections leading to reduced brightness and contrast at a viewing image plane.

Furthermore, known coupling fluids typically have a rate of change of index of refraction with temperature, dn/dT, that is substantially higher than the dn/dT of other optical elements in the projection system. For example, known coupling fluids typically have a dn/dT of about −30.0×10⁻⁵/° C. In contrast, dn/dT of plastic lens elements is typically about −10×10⁻⁵/° C., and dn/dT of a glass CRT face plate is typically +0.4×10⁻⁵/° C. A large dn/dT can lead to an unacceptable change in the overall focal length and magnification of the projection display. For example, contrast and resolution of a CRT projection display that includes a fluid optical coupler, can change substantially during warm up, where indices of refraction of some optical components including the optical coupler, the lens elements, and the CRT face plate, change as the temperature of the components increases from room temperature to the operating temperature. Furthermore, changes in focal length and magnification can be different for each primary color leading to, for example, an error in registration between the images formed by the three CRT image sources on a viewing screen.

Change in index of refraction of a plastic or liquid optical element is typically a result of change in density of the element due to, for example, thermal expansion or contraction of the element. For example, as the temperature of the element increases, the element expands leading to a decrease in index of refraction due to a decrease in density. Similarly, a decrease in temperature can result in the element contracting which can lead to an increase in the refractive index of the element due to an increase in density. Accordingly, dn/dT of an optical element is often negative. Some materials, such as some glasses or semiconductors, have a positive dn/dT due to, for example, a change in polarizability as discussed in, for example, U.S. patent application 2002/0120048.

Thermal expansion or contraction of an optical lens in a CRT projection system can change the optical properties of the lens. For example, the focal length and magnification of the lens can change. Furthermore, a change in the temperature of the lens element can lead to a change in the shape of the lens. Such a change can affect both on-axis and off-axis properties of the lens. For example, such a change can introduce or increase undesirable aberrations.

An optical coupling material is described for optically coupling a face plate of a CRT image source to a projection lens system. The optical coupling material includes a fluid host material housed in a coupler housing. The optical coupling material further includes nano-particles dispersed in the fluid host material. The average size of the nano-particles is preferably no more than 30 nm. The optical coupling material has an index of refraction n₂. The CRT image source can form an image at the face plate of the CRT, for example, at the input face of the face plate. The index of refraction of the face plate is n₁. The projection lens system is employed to magnify and project the source image onto a viewing screen, typically a projection screen. The projection lens system can include one or more projection lens elements. Typically, the projection lens system includes at least three, typically four, lens elements, a first lens element being closest to the CRT face plate. The index of refraction of the first lens element is n₃. The optical coupling material can include small particles dispersed in a host material.

An advantage of the present invention is high optical clarity of the optical coupler. Haze or optical scattering in an optical coupler can reduce display resolution and contrast. The optical coupling material of the present invention can have a high degree of optical transmission including a high specular optical transmission. The optical coupling material of the present invention can have very low optical haze. The particles in the optical coupling material can be small enough to introduce little or no optical scattering. For example, the small particles can be nano-particles, meaning that average particle size is in the nanometer range, for example, no more than 500 nm, such as in the range from 10 to 50 nm. As such, the optical coupling material can have little or no adverse effect on the resolution and contrast of the CRT projection display.

Another advantage of the present invention is efficient optical coupling of a CRT face plate to a first lens element. For example, the index of refraction of the optical coupling material can be such to efficiently match the index of refraction of the face plate to that of the first lens element. According to one embodiment of the present invention, the index of refraction of the optical coupling material, n₂, can be equal to or larger than the lower of n₁ and n₃. Furthermore, n₂ can be equal to or lower than the higher of n₁ and n₃. The index matching property of the optical coupling material can reduce optical reflection and, therefore, enhance brightness, resolution and contrast of the image displayed on a viewing screen.

According to another embodiment of the invention, n₂ can be the average of n₁ and n₃. In some applications, n₂ may be the square root of the product of n₁ and n₃. In some other applications, n₂ may be equal to n₁ or n₃.

Another advantage of the present invention is reduced rate of change of index of refraction with temperature, dn/dT, where T is temperature. Known optical coupling materials are typically organic fluids. As such, dn/dT of known optical couplers can be substantially higher than those of some other optical elements in the projection system, such as the CRT face plate and the lens elements that are made, for example, of glass or plastic. For example, dn/dT of known fluid optical coupling materials can be, at least, twice as high as other optical elements in the projection display, such as the CRT face plate and the lens elements. A high dn/dT can lead to a noticeable change in the overall focal length and magnification as a function of temperature, sometimes referred to as thermal drift. The change can affect resolution and contrast of the viewing image as a function of temperature, both on and off axis. Furthermore, in projection displays employing three CRT image sources, each having a dedicated projection lens system, the thermal drift can be different for each projection system. This can lead to misregistration between two or more projected images, both on and off axis. Addition of small particles to a fluid host material of an optical coupling material can reduce dn/dT of the optical coupling material leading to reduced thermal drift.

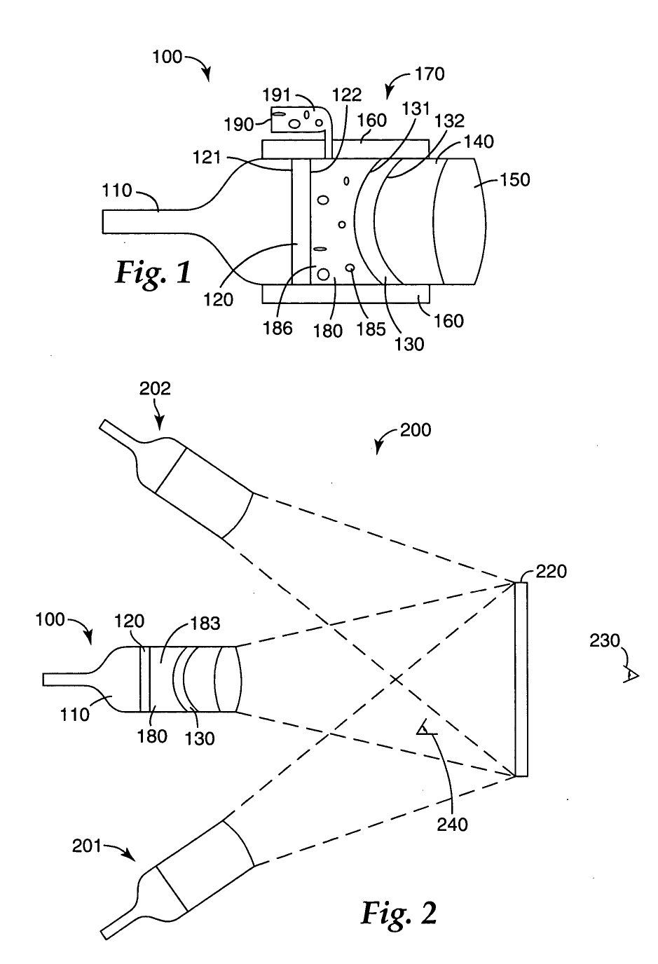

FIG. 1 illustrates a schematic side-view of an optical element 100 in accordance to one embodiment of the present invention. Optical element 100 includes a CRT 110, a CRT face plate 120 having an index of refraction n₁, an optical coupling material 180 having an index of refraction n₂, and a projection lens system 170. Projection lens system 170 includes a first lens element 130 having an index of refraction n₃. Projection lens system 170 can further include additional lens elements such as lens elements 140 and 150. Face plate 120 has an input face 121 and an output face 122. Similarly, the first lens element 130 has an input face 131 and an output face 132. Optical coupling material 180 can include small particles 185 dispersed in a host medium 186. Optical coupling material 180 has high optical transmission and low haze. Haze is typically a measure of cloudiness. Haze, as used in the specification, is a percentage of light diffusely transmitted compared to total transmitted light. Optical coupling material 180 preferably has a haze no more than 2%, more preferably no more than 1%, and even more preferably no more than 0.5%, and still even more preferably no more than 0.2%. Optical scattering and haze can be affected by the size of particles 185. In general, as the particle size decreases, the optical scattering and haze decrease. Furthermore, optical scattering and haze can be affected by a mismatch between the index of refraction of particles 185 and index of refraction of host material 186. In general, as the index mismatch decreases, the optical scattering and haze decrease. It is often easier to control the range of particle size than the index mismatch between the particles and the host material. For example, an upper end of particle size range may be controlled by passing the particles through a screen. In contrast, it may be difficult to control the index mismatch between the particles and the host material over a desired wavelength range, such as the visible range. This may be so because of variation in composition of particles and host material. Furthermore, it is generally difficult to match index dispersion of the particles and the host material as a function of temperature and/or wavelength. As such, particles 186 preferably are sufficiently small to reduce optical scattering and haze to acceptable levels. In particular, small particles 185 are preferably nano-particles, meaning that the average particle size is in the nanometer range. Even more particularly, the average size of particles 185 is preferably no more than 500 nm. The average size of particles 185 is more preferably in the range from 10 to 100 nm. The average size of particles 185 is even more preferably in the range from 10 to 50 nm, and even more preferably in the range from 10 to 30 nm. It will be appreciated that larger particles may be used where, for a given application, the index mismatch between particles 185 and host material 186 is sufficiently small to result in low optical scattering and haze. Particle size can be particle diameter where, for example, particles are spherical or approximately spherical, or where, in general, it is reasonable to assign a diameter to a particle. Particle size may be an average of particle dimension along different directions. For example, where particles are rod-shaped, particle size may be an average of particle dimension along its major and minor axes. In some applications, particle size may be the largest particle dimension.

According to one embodiment of the invention, particles 185 are colloidally dispersed in the host medium 186 so that at least a majority of particles 185 remain dispersed in host medium 186 for at least the expected lifetime of optical element 100. Expected lifetime of optical element can be application dependent. For example, an expected lifetime of a consumer rear projection television can be about 20,000 hours. In such an application, a majority of particles 185 can remain dispersed in host medium 186 for at least 20,000 hours.

Furthermore, according to one embodiment of the invention, particles 185 do not aggregate for the expected lifetime of optical element 100, or any aggregation that may occur during the expected lifetime of optical element 100 does not result in a significant light scattering or haze.

According to one embodiment of the invention, particles 185 have a positive dn/dT. An example of such a particle system is magnesium oxide described in U.S. Pat. No. 6,441,077. In some embodiments of the invention, particles 185 have a negative dn/dT.

According to one embodiment of the invention, surfaces of particles 185 may be treated to facilitate and maintain dispersion. The surface treatment is preferably compatible with the host medium 186, meaning that the treated particles 186 remain soluble or dispersable in the host material. An appropriate surface treatment can reduce or eliminate particle precipitation and/or aggregation.

According to one embodiment of the invention, n₂ is approximately a linear function of weight or volume fraction of particles 185 in optical coupling material 180. For example, the relationship between n₂, the index of refraction of the host material 186, n_{b}, and the index of refraction of particles 185, nₐ, can often be estimated by the relation:
n₂=n_{b} (1−VF)+nₐ (VF) (1)
where VF is a volume fraction of particles 185 in the optical coupling material 180. Volume fraction VF is generally defined as the ratio of volume of particles 185 to the total volume, where the total volume is the volume of the host material 186 with particles 185 dispersed therein. Volume fraction VF can be determined, for example, by first measuring the volume of fluid host material 186, V₁. Next, particles 185 are added to the fluid and the volume of the mixture, V₂, is measured. Accordingly, the volume of added particles 185 is V₂-V₁. Volume fraction of particles 185, VF, is determined by calculating the ratio (V₂-V₁)/V₂. A similar approach may be used to determine weight fraction of particles 185 by using weights rather than volume. Referring back to relation (1), the rate of change of indices of refraction is often estimated by the relation:
dn₂/dT=dn_{b}dT(1−VF)+dnₐ/dT(VF) (2)
where T is temperature. Accordingly, dn/dT of the optical coupling material can be a linear function of the volume fraction of particles 185 in the host material 186. According to relation (2), as the volume fraction of particles increases, dn₂/dT approaches dnₐ/dT. Particles 185 can have a dn/dT that is in the same range as some of the other optical components in optical element 100, such as face plate 120 or first lens element 130. For example, face plate 120 may be made of glass and particles 185 may be inorganic, such as silica. Since glass and silica have comparable values of dn/dT, by increasing the volume fraction of particles 185, dn/dT of the optical coupling material 180 can approach dn/dT of the face plate. Hence, dn/dT of the optical coupling material can be in the same range as that of the face plate.

A particular advantage of the present invention is reduced dn₂/dT. According to one embodiment of the invention, dn₂/dT is preferably at least 15% less than dn_{b}/dt, more preferably at least 20% less than dn_{b}/dt, even more preferably at least 30% less than dn_{b}/dt, even more preferably at least 40% less than dn_{b}/dt, and still even more preferably at least 50% less than dn_{b}/dt. The reduction in dn/dT is preferably over a temperature range from 20° C. to 60° C., more preferably from 20° C. to 70° C., and even more preferably from 10° C. to 80° C. In general, an upper limit of volume fraction VF may be controlled by the ability of particles 185 to remain dispersed in the host material 186 whereas a lower limit of volume fraction may be established by a desired value for dn₂/dT. According to one embodiment of the invention, volume fraction VF is preferably in the range from 10% to 80%, more preferably 10% to 60%, and even more preferably 10% to 40%. Although the values given above are in relation to volume fraction of particles 185, same or similar preferred values may be appropriate for weight fraction of particles 185.

Optical coupling material 180 is preferably fluid where by fluid it is meant any material that can flow including, but not limited to, liquids, gels and sol gels. In some applications, a solid optical coupling material may be used. Solid materials incorporating small particles have been previously described. For example, U.S. Pat. No. 6,586,096 describes a polymethylmethacrylate material with magnesium oxide particles, in the ten nm size, dispersed therein. Other examples may be found in U.S. Pat. Nos. 6,552,111; 6,441,077; 4,710,820 and 6,498,208; and U.S. patent Publication Nos. 2002/0123549 and 2002/0123550. An advantage of a fluid optical coupling material is high heat transfer. Temperature of face plate 120 can reach 70° C. or higher when CRT 110 is activated. It is desirable for optical coupling material to transfer the heat generated in face plate 120 away from the face plate to a surrounding area. For a solid optical coupling material, transfer of heat from face plate 120 to optical coupling material 180 is primarily done via conduction. In contrast, in a fluid type optical coupling material, transfer of heat from face plate 120 to optical coupling material 180 is primarily done via convection. In such a case, the convection can be natural or forced. In a forced convection, fluid flow is, at least in part, induced by an external force, such as a circulating pump. In a natural convection, fluid flow is primarily due to the properties of the fluid itself, where, for example, a cooler fluid that is farther away from the face plate displaces a warmer fluid that is closer to the face plate, or vice versa. Thermal conductivity is a measure of the ability of a material to conduct heat. In general, liquids have a higher thermal conductivity than solid polymers. For example, the thermal conductivity of polystyrene is about 0.12 Watts/mK where K is degrees Kelvin. In contrast, the thermal conductivity of ethylene glycol is about 0.26 Watts/mK, and thermal conductivity of water is about 0.6 Watts/mK. Accordingly, in general, fluids are more efficient in transferring heat generated in face plate 120 to a surrounding area.

A fluid optical coupling material 180 may include a fluid host material 186. Exemplary fluid materials for optical coupling material 180 and host material 186 include ethylene glycol, alkyl diaryl alkanes, mixtures of ethylene glycol and glycerol, mixtures of ethylene glycol and water, liquids including a siloxane polymer having methyl, phenyl, and hydrophilic side groups, and liquids including mixtures of a siloxane polymer having methyl and phenyl side groups and a siloxane polymer having methyl and hydrophilic side groups. In general, the fluid material can be any suitable fluid that can be used in a desired application.

Fluid host material 186 preferably has a high boiling point and a low freezing point. The boiling point of host material 186 is preferably no less than 120° C., and more preferably no less than 160° C., and even more preferably no less than 200° C. The freezing point of host material 186 is preferably no greater than −20° C., and more preferably no greater than −40° C., and even more preferably no greater than −60° C.

Particles 185 are preferably nano-particles, although in some applications and depending on the difference between n₂ and n_{b}, larger particles, such as micro-particles, may be used. In general, it is difficult to reduce the difference between n₂ and n_{b} to a sufficiently low and acceptable level for all CRT operating temperatures and wavelengths. Thus, according to one embodiment of the invention, the average size of particles 185 are preferably no more than 500 nm, more preferably no more than 100 nm, and even more preferably no more than 50 nm, and still even more preferably no more than 30 nm. Average size can be the mean or median size, or any other average that may be commonly used to characterize size of particles.

Face plate 120 is preferably made of any type of an optically transparent glass. Exemplary glass materials include soda lime glass, borosilicate glass, borate glass, silicate glass, oxide glass and silica glass, or any other glass material that may be suitable for use as a face plate. Face plate 120 in FIG. 1 is shown to have a rectangular cross-section. In general, face plate 120 can have any shape cross-section. In general, face plate input face 121 and output face 122 need not have the same shape. For example, input face 121 can be curved while output face 122 can be straight or flat. As another example, output face 122 can be curved. Furthermore, face plate 120 can have optical power, thereby acting, in part, as a lens. Optical coupling material 180 can be in contact with face plate 120. In particular, optical coupling material 180 can be in contact with output face 122 of face plate 120. In some applications or designs, other components may be disposed between face plate 120 and optical coupling material 180.

Optical element 100 may further include a coupler housing 160 for housing the optical coupling material 180. Coupler housing 160 may be necessary where the optical coupling material includes a fluid. In such a case, the housing may include one or more sealing mechanisms, not shown in FIG. 1, to seal in the optical coupling material. Coupler housing 160 may primarily be designed to house optical coupling material 180. Optical coupler housing 160 may be further designed to house additional elements, such as first lens element 130 and face plate 120. In general, optical element 100 may include one or more housings to house the various elements and components. Coupler housing 160 may be made of metal or plastic. Exemplary metal materials include aluminum, copper, magnesium and zinc. In general, coupler housing 160 may be made of any material suitable to house the optical coupling material 180.

Furthermore, optical element 100 may include a mechanism, such as a pump, not shown in FIG. 1, to circulate a fluid optical coupling material 180. A circulating optical coupling material can enhance the transfer of heat from face plate 120. In addition, optical element 100 may include an optional reservoir 190 for housing excess optical coupling material 191, for example, to help with fluid circulation or prevent formation of bubbles in the optical path in the event of a fluid leak. Reservoir 190 may be partially full to allow expansion of fluid. An example of such an expansion chamber is described in U.S. Pat. No. 4,740,727.

For simplicity and without loss of generality, the first lens element 130 in FIG. 1 is shown to have a curved cross-section. First lens element 130 may have an optical power. First lens element 130 may have field correcting properties for correcting or improving image quality across a viewing screen both on and off axis.

First lens element 130 may be made of plastic or glass. It is generally desirable to make a lens element in a CRT projection system, when possible and appropriate, out of plastic rather than glass. Plastic lenses are more cost effective. Furthermore, plastic lenses may be molded to have, for example, an aspherical shape. The use of aspherical lenses can generally reduce the overall number of lenses required in a projection system to produce an acceptable projected image across a viewing screen. Accordingly, when possible, optical elements, such as lenses, in a CRT projection system are made of plastic. It is also desirable for the optical elements, especially the elements having an optical power, to have a low dn/dT. As such, magnifying lenses in a CRT projection system are typically made of glass which has a low dn/dT approximately in the range from 10⁻⁵ to 5×10⁻⁶/° C. or less.

Typical plastic materials used in first lens element 130 include acrylic. Second lens element 140 and third lens element 150 may be made of glass or plastic. Optical coupling material 180 is preferably in contact with lens element 130. In particular, optical coupling material 180 is preferably in contact with the input face 131 of first lens element 130. In some applications and/or designs, other optical components may be disposed between the optical coupling material 180 and first lens element 130.

Optical element 100 may include other components that for simplicity and without loss of generality are not shown in FIG. 1. For example, optical element 100 can include one or more layers of phosphor disposed, for example, on input face 121 of face plate 120. As another example, optical element 100 can include mounts for supporting and keeping various elements in place, and additional lens elements.

Indices of refraction described in the invention may be measured at a particular wavelength of interest. For example, indices of refraction may be measured at a Sodium D line (approximately 590 nm), or at a desired laser wavelength, such as 633 nm (HeNe laser). Indices of refraction may be measured at one or more CRT primary emission lines, such as red (e.g., 624 nm), green (e.g., 544 nm), or blue (e.g., 455 nm). Indices of refraction may also be average values, for example, over the visible region. The visible region may include the range from 420 to 650 nm. In such a case, index may first be measured at several wavelengths (for example, CRT primary emission lines). The measured values may then be fit to a formula, for example, a Sellmeier dispersion formula, to generate an index versus wavelength dispersion curve. Next, an average for the index may be determined by, for example, calculating the area under the dispersion curve in a desired wavelength range, such as the visible range, and dividing the calculated area by the wavelength range.

Particles 185 may be organic or inorganic or combinations thereof. Particles 185 can include oxides, fluorides, and sulfides. For example, particles 185 may include silica, alumina, titania, ceria, zirconia, yttria and zinc oxide. Particles 185 preferably have low optical absorption in the wavelength region of interest, such as the visible region. Some particle materials such as silica can have little or no optical absorption in the visible range. Some other particles, such as titania, can slightly absorb in the visible. Still some other particles, such as ceria, can have high optical absorbance especially in the blue region of the spectrum. Optical transmittance of particles 185 is preferably greater than 90% in the visible region, more preferably greater than 98%, and even more preferably greater than 99.5%. It will be appreciated that a particle that absorbs light, for example, in the blue, but not in the red, may be used with a red CRT without adversely affecting image properties, such as brightness and contrast.

Particles 185 may have any shape. Particles 185 may have a random shape or a regular shape. Particles 185 may be oriented relative to a given direction or have a random orientation. Particles 185 may have a narrow size distribution or a large size distribution. Narrow size distribution generally refers to a particle size distribution that centers around a well-defined prominent peak. In contrast, a large or broad size distribution generally means that particle size distribution does not include a well-defined prominent peak, or that particle size distribution includes multiple peaks. Generally, as average particle size increases a narrower particle size distribution is preferred to reduce haze and optical scattering.

Particles 185 may include more than one type particles. For example, particles 185 may include particles of two different types A and B. Particles A may be primarily designed to reduce dn/dT of the optical coupling material 180. Particles B may be primarily designed to increase the index of refraction of the optical coupling material 180. In general, particles 185 may include one or more types of particles where different particles types may be primarily designed to meet different requirements.

FIG. 2 illustrates a schematic side-view of a projection display system 200 according to one embodiment of the invention. In the specification, a same reference numeral used in multiple figures refers to same or similar elements having same or similar properties and functionalities. Projection display system 200 includes an optical element 100 and a viewing screen 220. In a front projection display system, a viewer may be located on the same side of screen 220 as the optical element 100, such as position 240. In a rear projection display system, a viewer may be located on the opposite side of viewing screen 220, such as position 230.

Optical element 100 in FIG. 2 is similar to the optical element 100 described in reference to FIG. 1. In particular, optical element 100 includes a CRT image source 110 for forming an image. Optical element 100 further includes a face plate 120 having an index of refraction n₁, and a lens element 130 facing face plate 120 and having an index of refraction n₃. Lens element 130 magnifies and/or projects the image formed by the CRT image source 110. Optical element 100 may include additional lens elements to magnify and/or project an image formed by the CRT image source 110. Face plate 120 and lens element 130 can be arranged in spaced-apart opposing positions defining a coupler cavity 183. Optical element 100 further includes an optical coupling material 180, having an index of refraction n₂, disposed between face plate 120 and lens element 130. Optical coupling material 180 includes small particles, for example, nano-particles, dispersed in a host material. The host material is preferably fluid although in some applications, the host material may be solid. A coupling fluid may be dispersed within the coupler cavity 183. In one embodiment of the invention, n₂ is no lower than the lowest and no higher than the highest of n₁ and n₃.

Viewing screen 220 receives a source image magnified and/or projected by lens element 130 and other lens elements that may be included in the optical element 100. Projection system 200 may have a single CRT-based optical element 100. In such a case, optical element 100 may be designed to generate a color image. In some applications, optical element 100 may be designed to generate a monochromatic image that is magnified and projected onto viewing screen 220. Projection display system 200 may include more than one CRT image source. For example, in addition to the optical element 100, projection system 200 may include optical elements 201 and 202, where optical elements 201 and 202 may be similar to optical element 100. In general, each of optical elements 110, 201 and 202 may include different lens and/or other elements including different optical coupling materials. In a three CRT projection display system, each of optical elements 100, 201 and 202 may be designed to generate a same image in a different primary color. For example, optical element 202 may generate, magnify and project a red image; optical element 100 may generate, magnify and project a green image; and optical element 201 may generate, magnify and project a blue image. The three projected images may be superimposed on the viewing screen 220 resulting in a color image.

In a front projection system 200, viewing screen 220 can be substantially optically reflective. In a rear projection system 200, viewing screen 220 can be substantially optically transmissive.

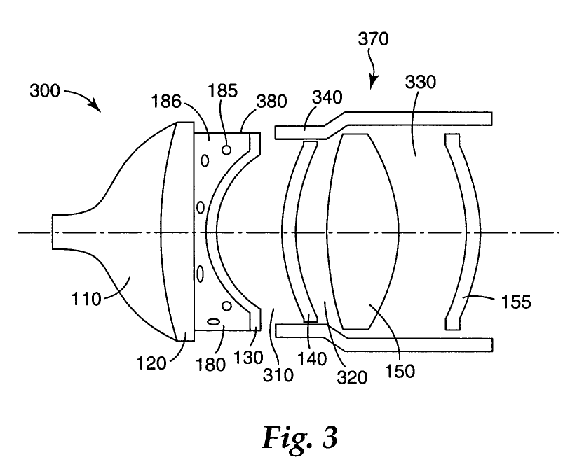

FIG. 3 illustrates a schematic side-view of an optical element 300 in accordance with another embodiment of the present invention. For ease of illustration and without loss of generality, some of the elements shown in FIG. 1 are not reproduced in FIG. 3. Optical element 300 includes a CRT 110, a CRT face plate 120, and a projection lens system 370. Projection lens system 370 includes a first lens element 130, a second lens element 140, a third lens element 150, and a fourth lens element 155. Fourth lens element 155 is typically an output lens, primarily designed to correct image aberrations, and is often referred to as an “A” lens. Second lens element 140 and third lens element 150, often referred to as “B” lenses, typically have optical power and are primarily designed to magnify an image produced by CRT 110. For example, third lens element 150 is often referred to as a “B1” lens and second lens element 140 is often referred to as a “B2” lens. First lens element 130 is often referred to as a “C” lens or a “C-shell” lens and is primarily designed to optically couple to CRT 110. An example of lens elements used in a CRT projection system may be found in U.S. Pat. No. 4,776,681; and U.S. Publication No. 2003/0071929.

Projection lens system 370 further includes a first gap region 310 disposed between the first and second lens element, a second gap region 320 disposed between the second and third lens elements, and a third gap region 330 disposed between the third and fourth lens elements. Optical element 300 further includes a mount 340 for housing the lens elements, for example, second, third and fourth lens elements, and for keeping the same in place.

Any one or more of the first, second, third and fourth lens elements can be made of glass or plastic, although generally, first lens element 130, second lens element 140, and fourth lens element 155 are made of plastic, and third lens element 150 is made of glass.

Third lens element 150 is generally designed to magnify an image, formed by CRT 110, for display onto a viewing screen (not shown in FIG. 3). As such, third lens element 150 is preferably made of a material with a low dn/dT, such as glass. First lens element 130, second lens element 140, and fourth lens element 155 are generally designed to improve properties of an image projected onto a viewing careen. Such image properties include contrast, resolution, and brightness. Each of the first, second, and third gap regions is generally an air gap, meaning that the region includes mostly air, although each of the gap regions may include a material other than air, such as a fluid material or a solid material.

According to one particular embodiment of the invention, first lens element 130 faces the face plate 120 defining a coupler cavity 380. Optical element 300 further includes an optical coupling material 180 disposed between face plate 120 and lens element 130 within the coupler cavity 380. Optical coupling material 180 includes small particles 185, for example, nano-particles, dispersed in a host material 186. The host material is preferably fluid although in some applications, the host material may be solid. A coupling host fluid material 186 may be dispersed within the coupler cavity 380.

Advantages and embodiments of the present invention are further illustrated by the following examples. The particular materials, amounts and dimensions recited in these examples, as well as other conditions and details, should not be construed to unduly limit the present invention.

### EXAMPLE 1

Silica particles were dispersed in propylene glycol coupling fluid. Mean particle size was 20 nm. Particles had an index of refraction of 1.46 measured at about 590 nm (a sodium D line). Index of refraction of propylene glycol was 1.432 at 590 nm at 20° C. Particle loading was 60% by weight. dn/dT of silica filled propylene glycol was about ½ of propylene glycol with no particles.

The silica filled propylene glycol had a haze of about 1.5%. Propylene glycol without particles had a haze of about 0.2%. Haze was measured using a Colorquest XE spectrophotometer from Hunterlab.

Next, thermal drift of a projection system was measured using propylene glycol with and ethylene glycol without particles as an optical coupling material. A CRT image source, similar to the optical element 100 of FIG. 1, with primary emission wavelength in the green (550 nm), was used to magnify and project an optical target onto a projection screen. The target included an opaque square bordering a clear square, sometimes referred to as an edge target.

First, an image of the target was projected onto the screen using propylene glycol without particles as an optical coupling material. The position of the source was determined for sharpest image at the screen at two different temperatures: 20° C. and 60° C. Thermal drift was defined as the shift in the source position for the two temperatures. Thermal drift was determined for a projected horizontal edge and a projected vertical edge. Furthermore, thermal drift was determined on-axis, at the 50% point (half way point between the image center and the image edge), and the 90% point (90% from the image center, 10% from the image edge). Next, the same experiments were repeated using the propylene glycol solution with particles dispersed therein as an optical coupling material. The resulting values for the projected vertical edge are given in Table 1 below. Similar values for the projected horizontal image are given in Table 2 below:

TABLE 1

Thermal drift (mm)
(Vertical Edge)

| | Solution without | Solution with | |
|---|---|---|---|
| | particles | particles | % Change |
| On-axis | 0.29 | 0.22 | 24 |
| 50% | 0.46 | 0.42 | 13 |
| 90% | 0.85 | 0.89 | −5 |

TABLE 2

Thermal drift (mm)
(Horizontal Edge)

| | Solution without | Solution with | |
|---|---|---|---|
| | particles | particles | % Change |
| On-axis | 0.29 | 0.22 | 24 |
| 50% | 0.35 | 0.32 | 14 |
| 90% | 0.53 | 0.49 | 8 |

Measured values listed in Tables 1 and 2 indicate that addition of nano-particles to propylene glycol can substantially reduce thermal drift.

### EXAMPLE 2

Silica particles were dispersed in an ethylene glycol coupling material fluid. Average size of silica particles was 20 nm. The particles had an index of refraction 1.433 at about 590 nm (a sodium D line). Index of ethylene glycol was 1.431 at 590 nm. Particle loading was 30% by weight. The measured value of dn/dT of silica filled ethylene glycol was −2.3×10⁻⁴. The dn/dT of ethylene glycol without particles was −2.7×10⁻⁴. The addition of particles reduced dn/dT by about 14.8%.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

1. An optical element comprising:
a face plate of a cathode ray tube having an average index of refraction n₁ over the visible range;
a lens element facing the face plate having an average index of refraction n₃ over the visible range; and
an optical coupling material disposed between the lens element and the face plate for optically coupling the face plate to the lens element, the optical coupling material having an index of refraction n₂ over the visible range, the optical coupling material comprising nano-particles dispersed in a fluid host material, the nano-particles having an average index of refraction nₐ over the visible range, and the host material having an average index of refraction n_{b} over the visible range.

2. The optical element of claim 1, wherein the fluid host material comprises one or more of ethylene glycol, glycerol, propylene glycol, alkyl diaryl alkane, water, and a siloxane polymer.

3. The optical element of claim 1, further comprising a coupler housing for housing the optical coupling material.

4. The optical element of claim 1, wherein n₂ is no lower than the lowest and no higher than the highest of n₁ and n₃.

5. The optical element of claim 1, wherein n₂ is the average of n₁ and n₃.

6. The optical element of claim 1, wherein n₂ is the square root of the product of n₁ and n₃.

7. The optical element of claim 1, wherein n₂ is equal to n₁.

8. The optical element of claim 1, wherein n₂ is equal to n₃.

9. The optical element of claim 1, wherein the optical coupling material is in contact with the face plate.

10. The optical element of claim 1, wherein the optical coupling material is in contact with the lens element.

11. The optical element of claim 1, wherein a weight fraction of the nano-particles in the optical coupling material is in the range from 10% to 80%.

12. The optical element of claim 1, wherein a weight fraction of the nano-particles in the optical coupling material is in the range from 20% to 70%.

13. The optical element of claim 1, wherein a weight fraction of the nano-particles in the optical coupling material is in the range from 30% to 70%.

14. The optical element of claim 1, wherein an average size of nano-particles is no more than 500 nm.

15. The optical element of claim 1, wherein an average size of nano-particles is in the range from 10 to 100 nm.

16. The optical element of claim 1, wherein an average size of nano-particles is in the range from 10 to 50 nm.

17. The optical element of claim 1, wherein an average size of nano-particles is in the range from 10 to 30 nm.

18. The optical element of claim 1, wherein the nano-particles are colloidally dispersed in the fluid host material.

19. The optical element of claim 1, wherein n₂ is a linear function of the weight fraction of nano-particles in the optical coupling material.

20. The optical element of claim 1, wherein a rate of change of n₂ with temperature T is a linear function of the weight fraction of nano-particles in the optical coupling material.

21. The optical element of claim 1, wherein a rate of change of n₂ with temperature is at least 5% less than a rate of change of n_{b} with temperature over a temperature range from 20° C. to 60° C.

22. The optical element of claim 1, wherein a rate of change of n₂ with temperature is at least 10% less than a rate of change of n_{b} with temperature over a temperature range from 20° C. to 60° C.

23. The optical element of claim 1, wherein a rate of change of n₂ with temperature is at least 15% less than a rate of change of n_{b} with temperature over a temperature range from 20° C. to 60° C.

24. The optical element of claim 1, wherein a rate of change of n₂ with temperature is at least 20% less than a rate of change of n_{b} with temperature over a temperature range from 20° C. to 60° C.

25. The optical element of claim 1, wherein a rate of change of n₂ with temperature is at least 25% less than a rate of change of n_{b} with temperature over a temperature range from 20° C. to 60° C.

26. The optical element of claim 1, wherein the optical coupling material has a haze no more than 2%.

27. The optical element of claim 1, wherein the optical coupling material has a haze no more than 1%.

28. The optical element of claim 1, wherein the optical coupling material has a haze no more than 0.5%.

29. The optical element of claim 1, wherein the optical coupling material has a haze no more than 0.2%.

30. The optical element of claim 1, wherein a rate of change of index of particles with temperature is positive.

31. The optical element of claim 1, wherein a rate of change of index of particles with temperature is negative.

32. A projection display system comprising:
a CRT image source for forming an image, the CRT having a face plate;
a lens element for projecting the image formed by the source, the lens element facing the face plate; and
an optical coupling material disposed between the lens element and the face plate for optically coupling the face plate to the lens element, the optical coupling material comprising nano-particles dispersed in a fluid host material.

33. The projection display system of 32, further comprising a viewing screen for displaying the image projected by the lens element.

34. The projection display system of 32 comprising three CRT image sources.

35. The projection display system of 32 being a front projection display system.

36. The projection display system of 32 being a rear projection display system.

37. A cathode ray tube projection system comprising:
a face plate of a cathode ray tube and a lens element arranged in spaced-apart opposing positions defining a coupler cavity; and
a coupling fluid dispersed within the coupler cavity, the coupling fluid including nano-particles.

38. The cathode ray tube projection system of claim 37 further comprising a coupler housing for housing the face plate, the lens element and the coupling fluid.
